(19) United States
(12) Patent Application Publication
(10) Pub. No.: US 2013/0125457 A1
(43) Pub. Date: May 23, 2013

(54) CROP HOOKS AND METHODS OF USING SAME

(71) Applicant: Santik Agri Corporation, Delta, CA (US)

(72) Inventor: Jean-Marc Pennors, Delta (CA)

(73) Assignee: Santik Agri Corporation, Delta (CA)

(21) Appl. No.: 13/669,328

(22) Filed: Nov. 5, 2012

Related U.S. Application Data
(60) Provisional application No. 61/556,092, filed on Nov. 4, 2011.

(51) Int. Cl. A01G 9/12

(52) U.S. Cl. CPC A01G 9/12
USPC 47/44; 47/58.1 FV

(57) ABSTRACT

A crop hook in accordance with one embodiment of the present disclosure generally includes first and second ends, at least one of the first and second ends having a first hook, and a body portion between the first and second ends, wherein the first hook is substantially non-planar with at least a portion of the body portion.

### CROSS-REFERENCE TO RELATED APPLICATION

This application claims the benefit of U.S. Provisional Patent Application No. 61/556092, filed Nov. 4, 2011, the disclosure of which is hereby expressly incorporated by reference herein in its entirety.

### BACKGROUND

Hanging crop hooks are typically used in the greenhouse industry, particularly for growing fruits and vegetables on vines or plants, such as tomatoes. Typically, these hooks are manufactured from metal wire and are designed to hang from a crop line in a greenhouse. The crop line is usually suspended in a substantially horizontal orientation from the greenhouse structure, and the crop hook is designed to hang twine in a substantially vertical orientation from the crop line to provide a climbing twine for the plants. The crop hook is removably couplable to the crop line, so that adjustments may be made manually by workers in the greenhouse as the plant grows.

Previously designed crop hooks (e.g., see FIG. 20), as described in greater detail below, allow for plant adjustment, but have not been optimized to reduce user injury. In that regard, the previously designed crop hooks require the users who are adjusting the plants to support the weight of the plants (usually in the range of about 3 to about 7 kg for tomato plants) with their hands, arms, and/or shoulders while making adjustments. Over time and with repetition, the weight of the plants causes great stress on the bodies of the users.

In view of this potential injury problem, there exists a need for an improved crop hook that can be efficiently manipulated by users, but reduces the physical demands on the users.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a crop hook is provided. The crop hook generally includes first and second ends, at least one of the first and second ends having a first hook, and a body portion between the first and second ends, wherein the first hook is substantially non-planar with at least a portion of the body portion.

In accordance with another embodiment of the present disclosure, a crop hook is provided. The crop hook generally includes first and second ends, at least one of the first and second ends having a first hook, and a body portion between the first and second ends, wherein the first hook is substantially non-planar with the body portion.

In accordance with another embodiment of the present disclosure, a crop hook is provided. The crop hook generally includes a first end having a first hook, a second end having a second hook, and a body portion between the first and second ends, wherein the body portion includes first and second twine holding portions, wherein each of the first and second hooks are substantially non-planar with at least a portion of the body portion.

In accordance with another embodiment of the present disclosure, a crop hook is provided. The crop hook generally includes first and second ends, the first end including a first hook and the second end including a second hook, wherein the first hook extends in a first direction relative to a longitudinal axis extending through the crop hook and wherein the second hook extends in a second direction relative to a longitudinal axis extending through the crop hook. The crop hook further includes a body portion between the first and second ends.

In accordance with another embodiment of the present disclosure, a method of using a crop hook is provided. The method generally includes supporting a crop twine on a crop hook, wherein the crop hook has a first end and a second end, hanging the crop hook on a crop line to hang the crop twine for supporting a plant having a plant weight, rotating the crop hook to release a length of twine from the crop hook without lifting the plant weight, and moving the crop hook a predetermined distance along the crop line without lifting the plant weight.

### DESCRIPTION OF THE DRAWINGS

The foregoing aspects and many of the attendant advantages of this disclosure will become more readily appreciated by reference to the following detailed description, when taken in conjunction with the accompanying drawings, wherein:

FIG. 1 is an isometric view photograph of a crop hook in accordance with one embodiment of the present disclosure;

FIG. 2 is a front view photograph of the crop hook of FIG. 1;

FIG. 3 is a front view of the crop hook of FIG. 1 in use along a crop line according to step that would simulate use of the crop hook in a crop environment according to one embodiment of the present disclosure;

FIGS. 4-7 are perspective views of the crop hook of FIG. 1 in a series of steps that would simulate the movement of the crop hook in a crop environment as seen in FIG. 3;

FIG. 8 is an isometric view photograph of a crop hook in accordance with another embodiment of the present disclosure;

FIG. 9 is a front view of the crop hook of FIG. 8 in use along a crop line according to step that would simulate use of the crop hook in a crop environment according to one embodiment of the present disclosure;

FIGS. 10-14 are perspective views of the crop hook of FIG. 8 in a series of steps that would simulate the movement of the crop hook in a crop environment as seen in FIG. 9;

FIGS. 15-19 are perspective views of the crop hook of FIG. 1 in a series of steps that would simulate the movement of the crop hook in a crop environment as seen in FIG. 9; and

FIG. 20 is a side view of a previously designed crop hook.

### DETAILED DESCRIPTION

The detailed description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or a substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

Embodiments of the present disclosure are generally directed to crop hooks, for example, for holding tomato vines in a green house environment. Although shown and described with respect to tomato vines, it should be appreciated that the crop hooks and methods of use described herein may be applied to other crops, for example, fruit and vegetable crops, such as cucumbers, and other crops capable of being grown on winding strings.

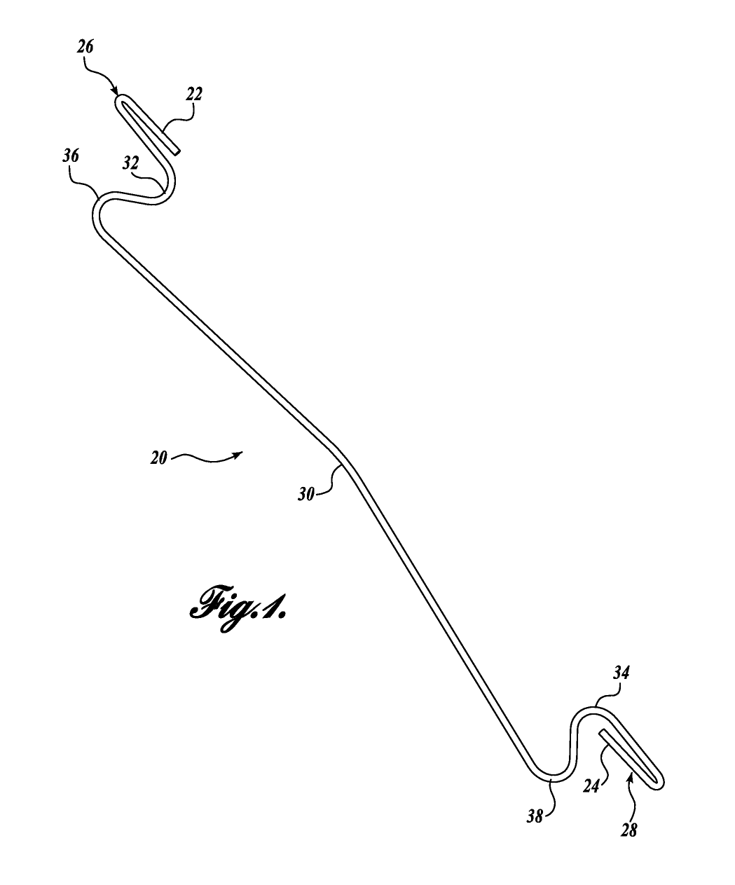

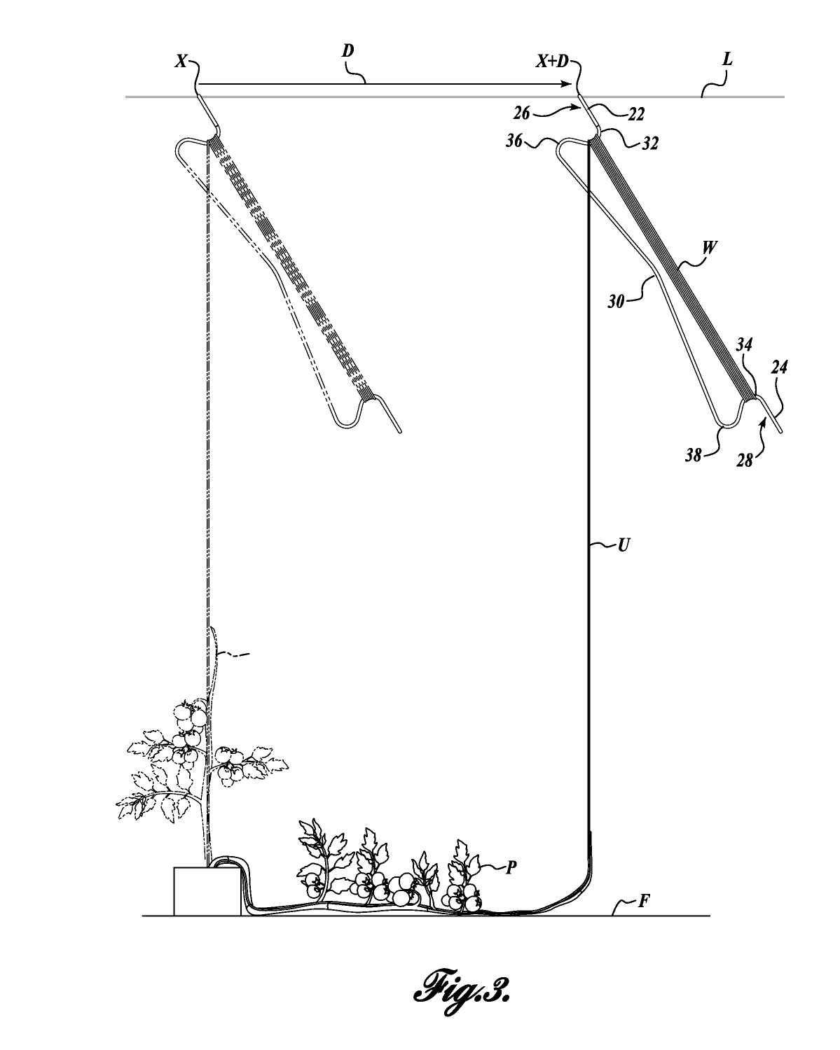

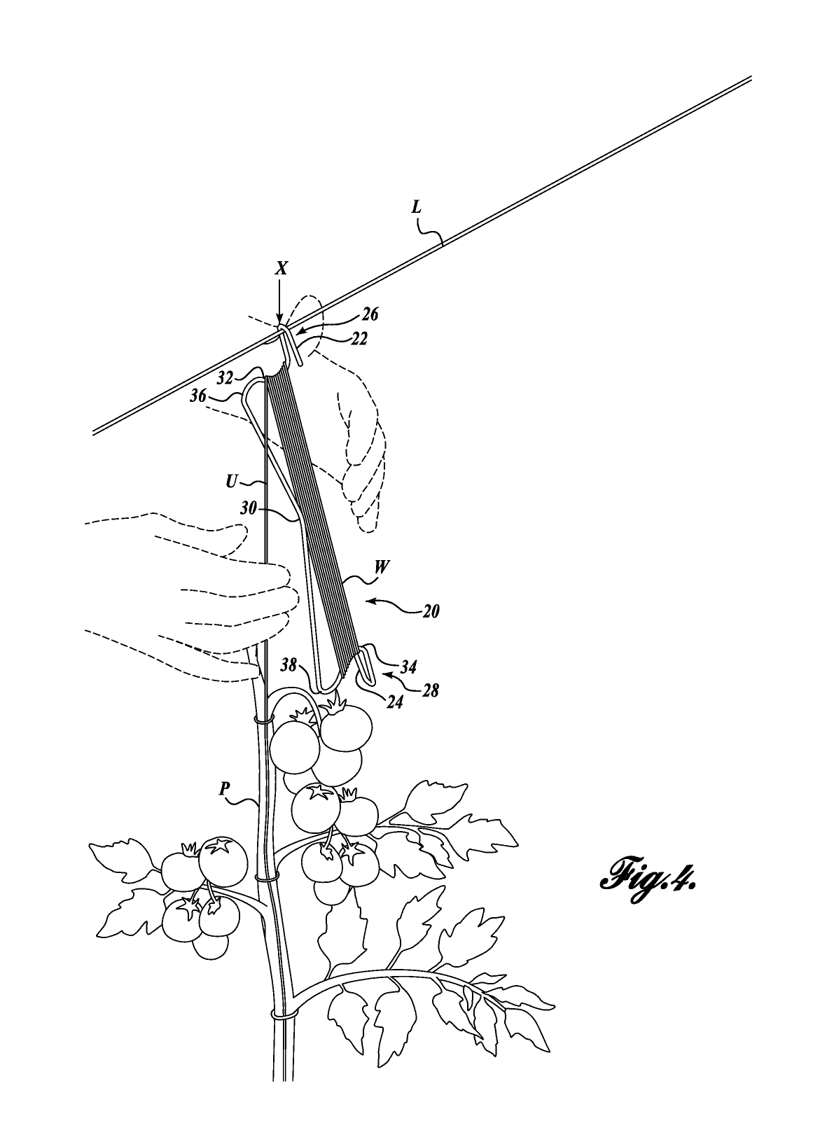

Referring to FIGS. 1-4, a crop hook 20 designed in accordance with one embodiment of the present disclosure is shown. The crop hook 20 includes first and second hooks 22 and 24 positioned at respective first and second ends 26 and 28 of the crop hook 20, and a center body portion 30 for receiving and holding one or more windings of twine W (see FIGS. 3 and 4). The body portion 30 has a serpentine configuration at the first and second ends 26 and 28 of the crop hook 30, defining first and second rounded twine collection portions 32 and 34 and first and second rounded twine holding portions 36 and 38.

In the illustrated embodiment, the first and second hooks 22 and 24 are “V” shaped hooks, which may be used to hook on a line for support, such as crop line L (see FIG. 4). However, it should be appreciated that the first and second hooks 22 and 24 may be “U” shaped hooks or another suitable shape for hooking to the crop line L.

In the illustrated embodiment, the first and second hooks 22 and 24 are positioned at each of the first and second ends 26 and 28 for ease of use. In that regard, the crop hook 20 may be conveniently used in the same manner in either of its upright or upside-down orientations. However, it should be appreciated that crop hooks manufactured with only one hook or having non-redundant hooks, for example, a first left-moving hook on the first end 26 and a second right-moving hook (as described in greater detail below) on the second end 28 are also within the scope of the present disclosure.

Moreover, in one embodiment, the crop hook 20 is manufactured from a single piece of metal wire, such as steel wire, and is designed to hang from a crop line L, for example, in a greenhouse. However, it should be appreciated that the crop hook 20 need not be manufactured from a single component and may include multiple discrete parts that are coupled or otherwise affixed to one another.

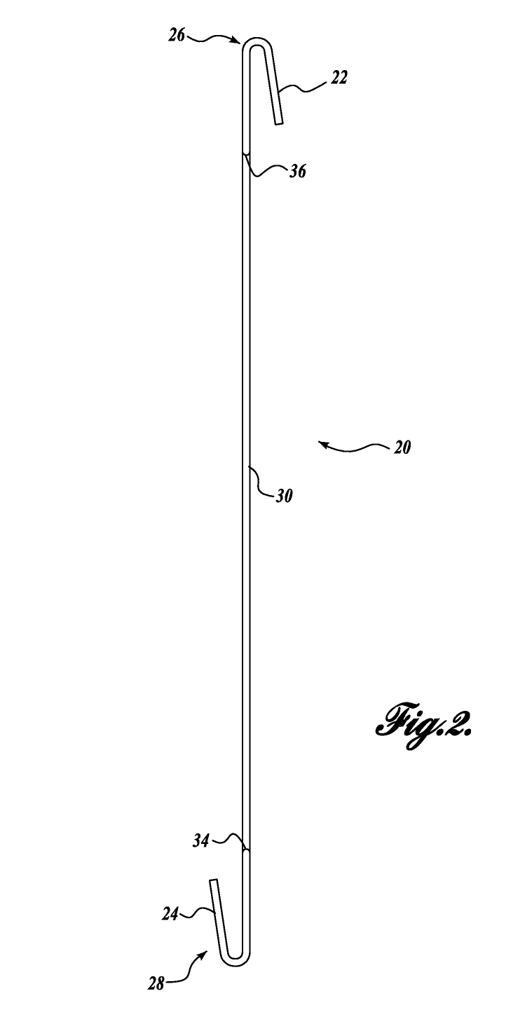

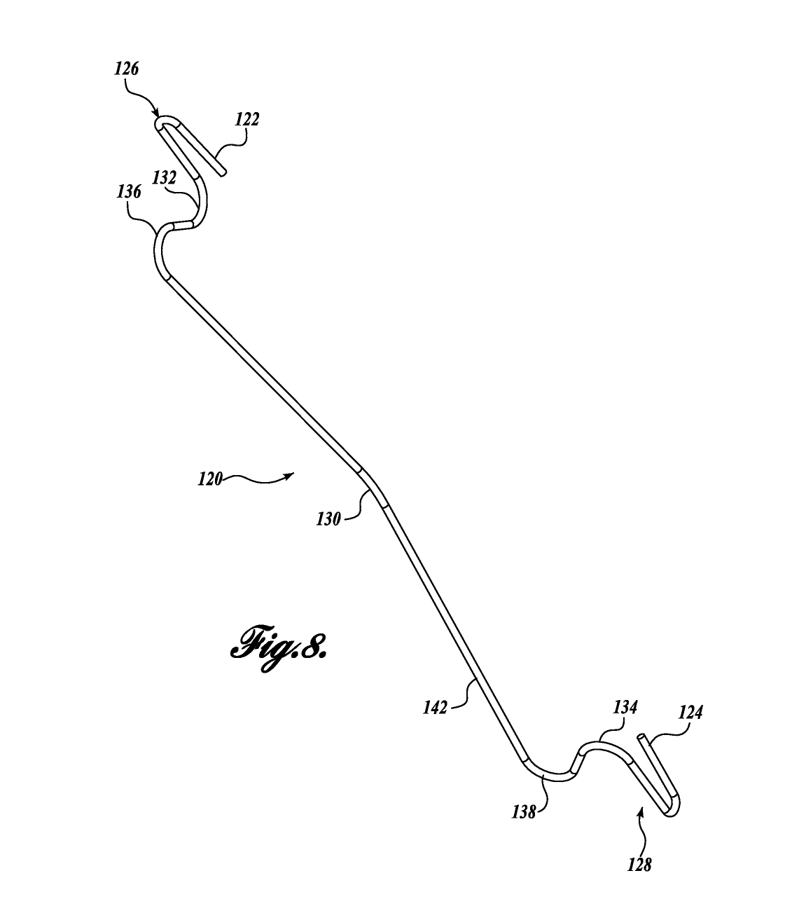

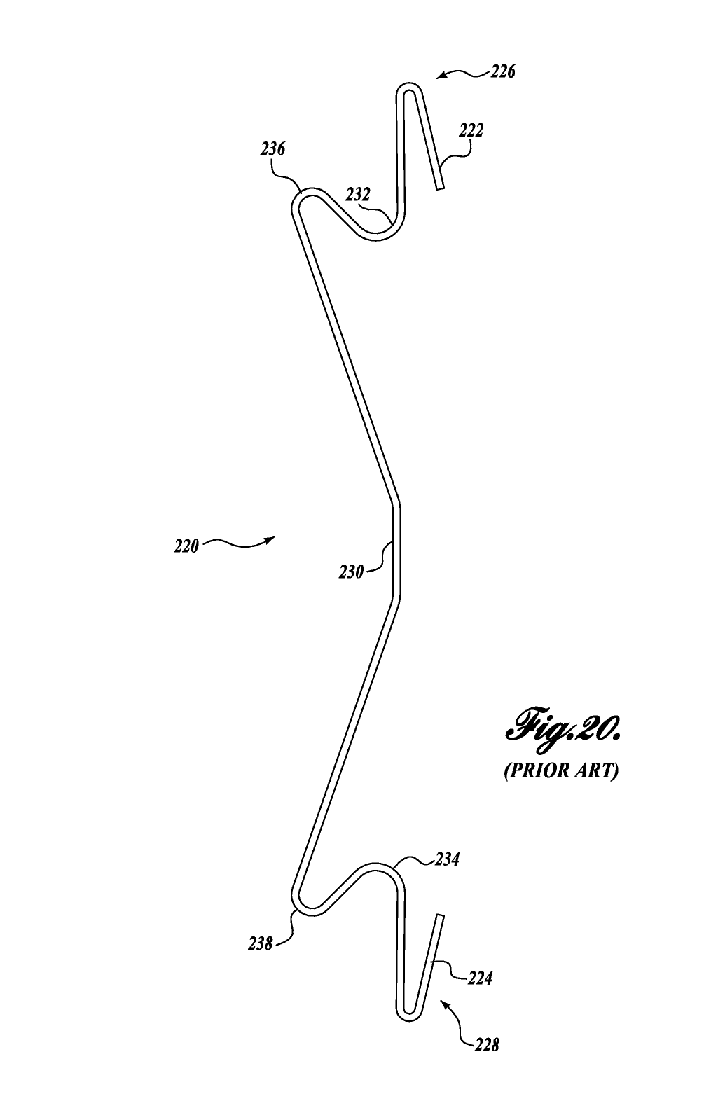

As can be seen in FIGS. 2 and 4, at least a portion of one of the first and second hooks 22 and 24 is substantially non-planar with the body portion 30 of the crop hook 20. In that regard, the crop hook 20 is manufactured to extend in three dimensions, with at least one of the first and second hooks 22 and 24 being angled relative to the body portion 30. (Compare the two-dimensional design of the previously designed crop hook 220, shown in FIG. 20.) In that regard, the first hook 22 extends in a direction relative to a longitudinal axis extending through the crop hook 20 and the body portion 30 extends in another direction. The second hook 24 may also extend in yet another direction, which may be either substantially planar (e.g., see FIG. 1) or substantially non-planar with the first hook 22 (e.g., see FIG. 8).

In the illustrated embodiment, the first and second hooks 22 and 24 are angled relative to the body portion 30 and relative to each other. As seen in FIG. 2, with the body portion 30 of the crop hook 20 protruding outwardly from the paper toward the reader, the first hook 22 has an open end to the right side of the body portion 30, and the second hook 24 has an open end to the left side of the body portion 30. Therefore, the first and second hooks 22 and 24 are oriented away from each other.

Although in the illustrated embodiment, the first and second hooks 22 and 24 appear to be angled about 90 degrees relative to the body portion 30, and therefore, about 180 degrees relative to each other, it should be appreciated that non-square angles of the first and second hooks 22 and 24 relative to the body portion 30 are advantageous. In that regard, an angle of 100+/−5 degrees relative to the body portion 30 may help the hooks 22 and 24 with grading on the crop line L to avoid unintentional slipping along the crop line L. In one embodiment, the first and second hooks 22 and 24 may be angled in different directions from the body portion 30 in the range of about 75 to about 105 degrees in each direction. In another embodiment, the first and second hooks 22 and 24 may be angled in different directions from the body portion 30 in the range of about 80 to about 100 degrees in each direction. In another embodiment, the first and second hooks 22 and 24 may be angled in different directions from the body portion 30 in the range of about 85 to about 95 degrees in each direction.

Still referring to FIG. 2, with the body portion 30 of the crop hook 20 protruding outwardly toward the user, the wound twine W is preferably wound in the clockwise direction around the body portion 30 (also see FIG. 4). As described in greater detail below, the wound twine W may also be wound in the counterclockwise direction around the body portion 30 of the crop hook 20.

Referring to FIGS. 3-7, a method of using the crop hook 20 will now be described. Referring to FIG. 4, the first hook 22 of the crop hook 20 hangs along the crop line L without user support at a first crop line position X, while the second hook 24 and the body portion 30 hang freely below the crop line L. As seen in FIGS. 3 and 4, depending on the design of the crop hook 20, the crop hook 20 itself may not hang directly downward. Rather, it may hang at an angle (for example, in the range of about 10 to about 20 degrees from vertical) from the crop line L as a result of the weighting of the crop hook 20, the wound (reserve) twine W, and the plant P attached to the unwound twine U. With more weight from the plant P on the unwound twine U, the crop hook 20 tends to hang at more of an angle from the vertical position. However, it is desirable for the crop hook 20 to hang at an angle closer to the vertical position to reduce any impediments to sunlight reaching the plant P.

Although the crop hook 20 itself may hang at an angle, the unwound twine U typically hangs in a substantially vertical orientation and travels from the crop line L to the floor F or near the floor of the greenhouse (see FIG. 3). In practice, the unwound twine U would have a plant P (see, for example, FIG. 3), such as a tomato vine, growing up along its length having a weight, for example, in the range of about 3 to about 7 kg. Several windings of wound twine W are wound around the body portion 30 of the crop hook 20 and are available for unwinding.

The illustrated embodiment of the crop hook 20 shown in FIGS. 1-7 is designed for movement by the user to the user's left along the crop line L a distance D. (Of note, the user is expected to be positioned behind the illustrated crop line L facing the crop line L in FIGS. 3-7; therefore, movement to the user's left is movement to the reader's right on the pages of FIGS. 3-7.) However, it should be appreciated that crop hooks 20 designed for movement to the user's right along the crop line L are also within the scope of the present disclosure. In that regard, a right-moving crop hook is substantially similar to the crop hook 20 of FIGS. 1-7, except that it is designed having the opposite configuration (i.e., with the first hook 22 facing left and the second hook 24 facing right in FIG. 2). Although not required, twine T would be preferably wound counterclockwise on the right-moving crop hook.

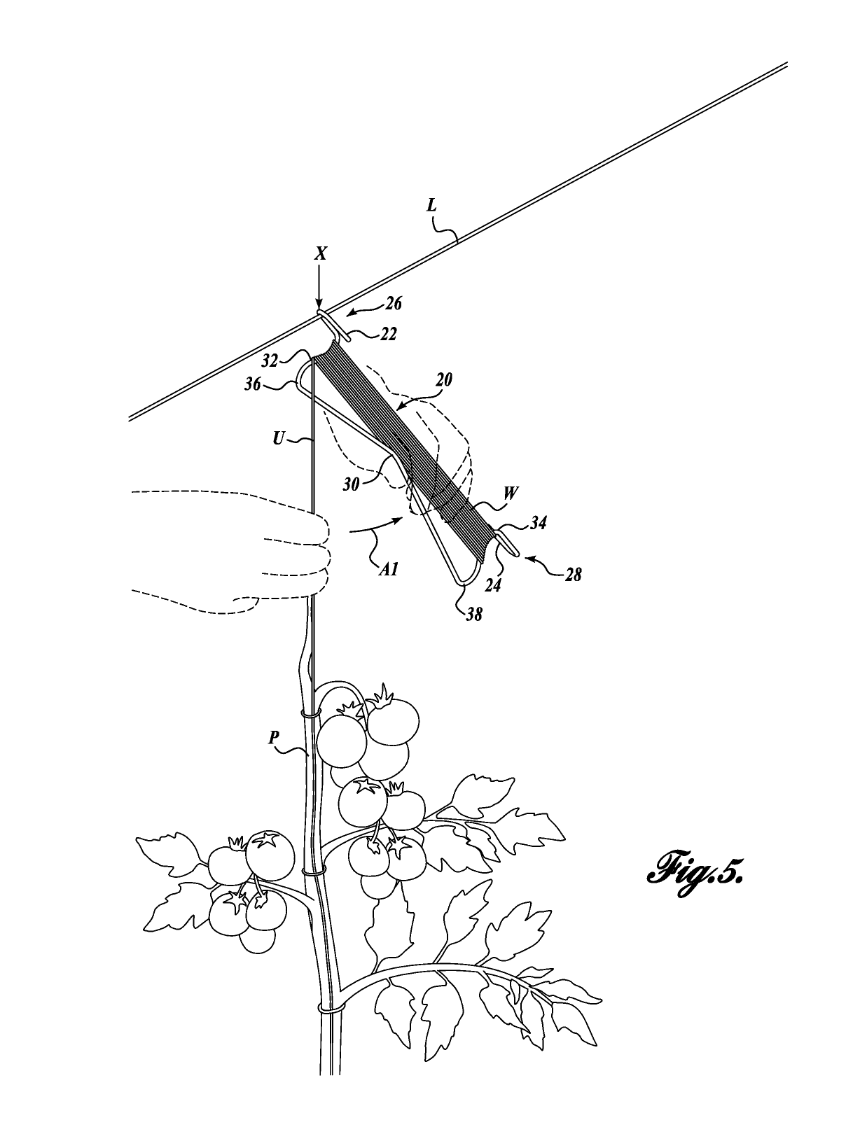

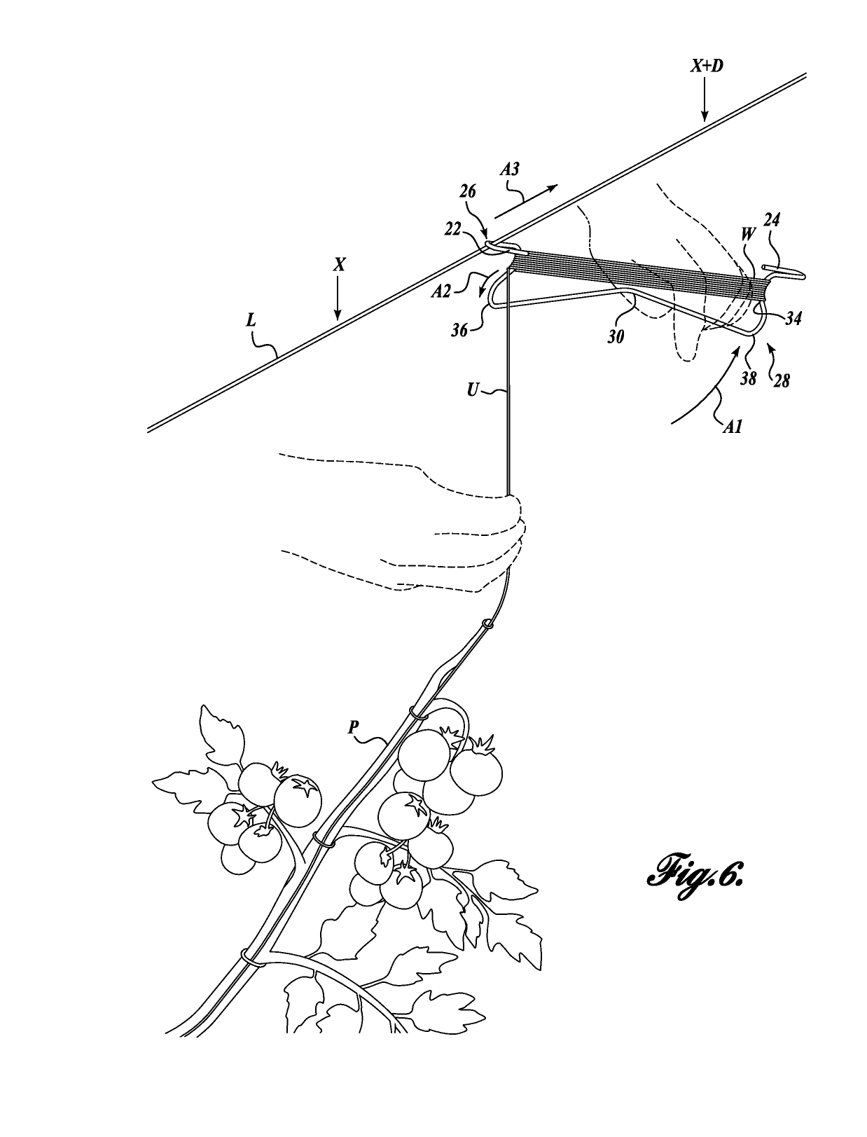

Referring now to FIGS. 5 and 6, the user uses his left hand to rotate the second end 28 of the crop hook 20 from its hanging position upward toward the crop line L and parallel with the crop line L, as indicated by arrow A1, while maintaining the first hook 22 on the crop line L. The user uses his right hand to hold the unwound twine U carrying the weight of the plant P.

Referring to FIG. 6, as the user rotates the second end 28 toward the crop line L, a winding of wound twine W slips over the first twine holding portion 36, as indicated by arrow A2, to provide a full winding length of unwound twine U to the plant P. As the twine W unwinds from the crop hook 20, the user guides the unwound twine U and the plant P into its new position with a portion of the vine of the plant P resting on the floor F of the environment (see, e.g., FIG. 3). Of note, no lifting of the plant P is required by the user, only the action of guiding the unwound twine U and the plant P downward to the new position on the floor F is performed according to this method of use.

The advantage of the method of adjusting the plant P described herein is that the user is not required to lift the unwound twine U and the plant P to release a winding of wound twine W off the crop hook 20, as required in previous methods using previously designed crop hooks 120 (see FIGS. 8-13). Such lifting action can result in repetitive lifting of significant plant weight (usually in the range of about 3 to about 7 kg). The improved crop hook 20 and method of use described herein removes the lifting action from the method of use.

As can be seen in FIGS. 5 and 6, the wound twine W is wound clockwise relative to the body portion 30 of the crop hook 20. In that regard, the wound twine W unwinds to slip over the first twine holding portion 36 toward the user's body, simplifying the unwinding act for the user. If wound counterclockwise, the wound twine W would unwind to slip over the first twine holding portion 36 away from the user's body. Either method is acceptable, depending on the user's preference. However, the inventor found that unwinding to slip over the first twine holding portion 36 toward the user's body tends to simplify the unwinding step for the user. As seen in FIGS. 1 and 3, the preferable shape of the first twine holding portion 36 is a rounded shape to help the user in releasing a wrap of wound twine W from the crop hook 20 as the user rotates the second end 28 toward the crop line L. (Compare the sharper shape of first twine holding portion 236 in the previously designed crop hook 220 of FIG. 20.)

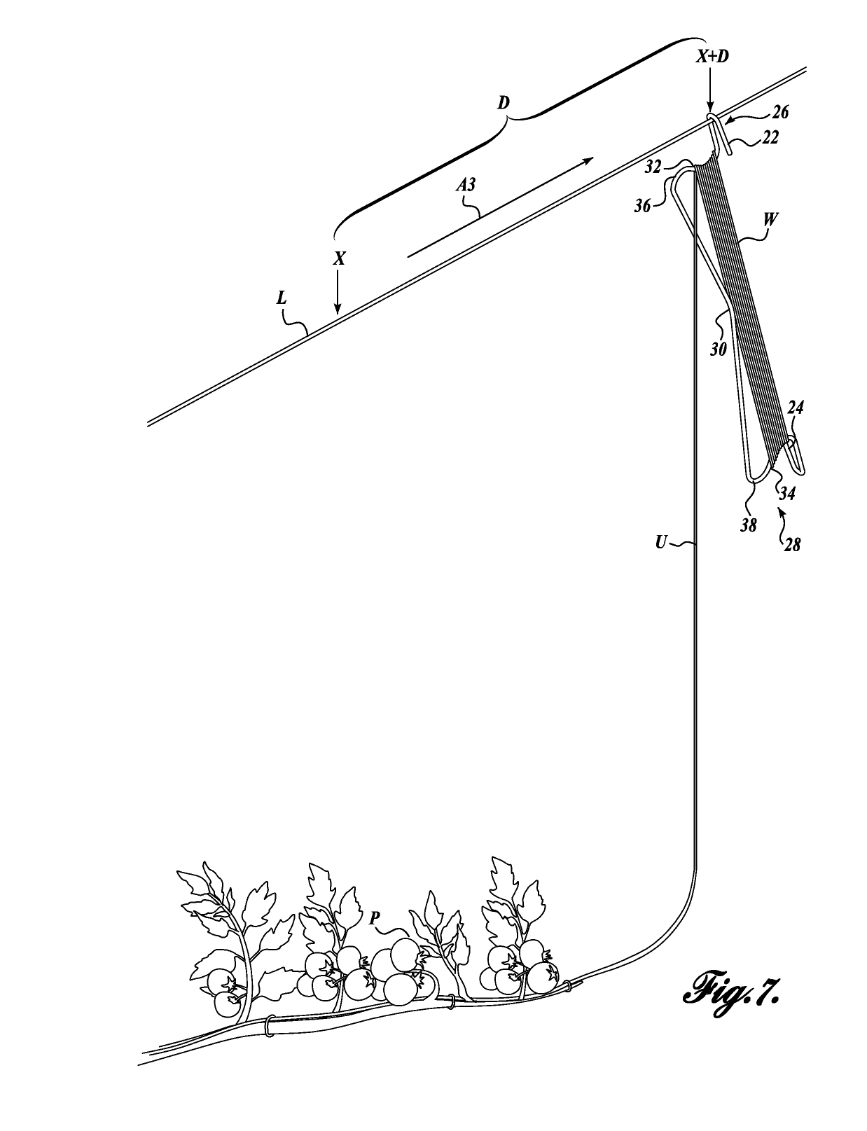

Referring now to FIG. 7, with slack in the unwound twine U, the user moves the crop hook 20 to his left along the crop line L a distance D, as indicated by arrow A3. In that regard, the user may slide or otherwise reposition the crop hook 20 along the crop line L. It should be appreciated that such movement to the user's left (see arrow A3 in FIG. 7) may be simultaneously performed with the rotational movement of the crop hook 20 relative to the crop line L (see arrow A1 in FIGS. 4 and 5) and the guiding of the unwound twine U and the plant P to the new position with on the floor F (see FIG. 3).

As seen in FIGS. 3 and 7, the crop hook 20 can be released from the user's hand such that the first hook 22 hangs along the crop line L without user support at a second crop line L position X+D and the second hook 24 and the body portion 30 hang freely below the crop line L. Therefore, as seen in the illustrated embodiment of FIG. 3, as the crop hook 20 moves to the user's left along the crop line L, the plant P lies down along the floor F of the greenhouse. Such action promotes plant growth such that the plant and fruits or vegetables on the plant may continue to grow at the top of the plant, while maintaining a relatively constant plant height to meet greenhouse height restrictions. A typical tomato plant will grow and continue to produce fruit in this environment in the range of about 7 to about 11 continuous months.

Although the crop hook 20 of FIGS. 1-7 is optimized for releasing a full winding length of wound twine W, it is not an optimized design for a half-turn to unwind a half winding length of wound twine W when a shorter release of twine is desired. Referring now to FIGS. 8-14, an alternate embodiment of a crop hook will be described, which is an optimized design for a half-turn and also can be used for a releasing a full winding length of wound twine W.

The crop hook 120 of FIGS. 8-14 is substantially similar to the crop hook 20 of FIGS. 1-7, except for differences regarding the configuration and orientation of the first and second hooks 122 and 124 and the body portion 130, which allows for a different method of use. Specifically, the crop hook 120 of FIGS. 8-14 is designed for a half-turn to unwind a half winding length of wound twine W, as opposed to the crop hook 20 of FIGS. 1-7 that is designed for releasing a full winding length of wound twine W. Like numerals are used for the crop hook 120 of FIGS. 8-14 as used for the crop hook 20 of FIGS. 1-7, but in the 100 series.

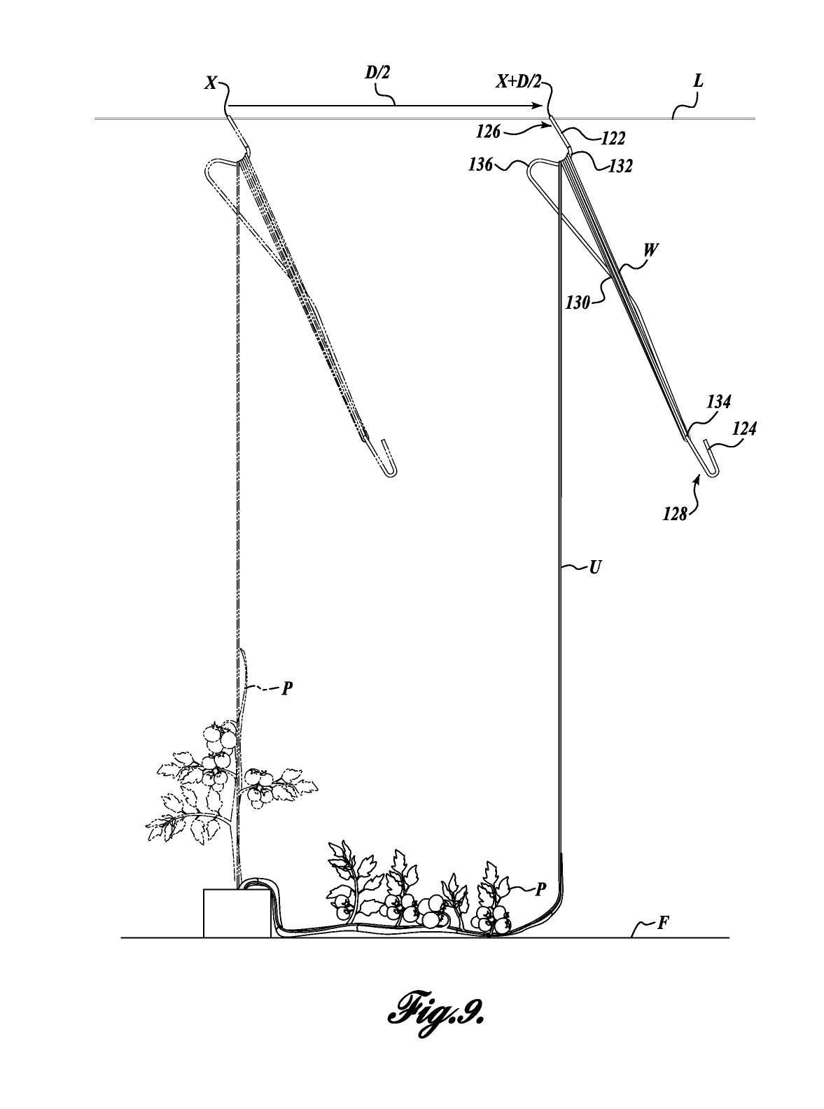

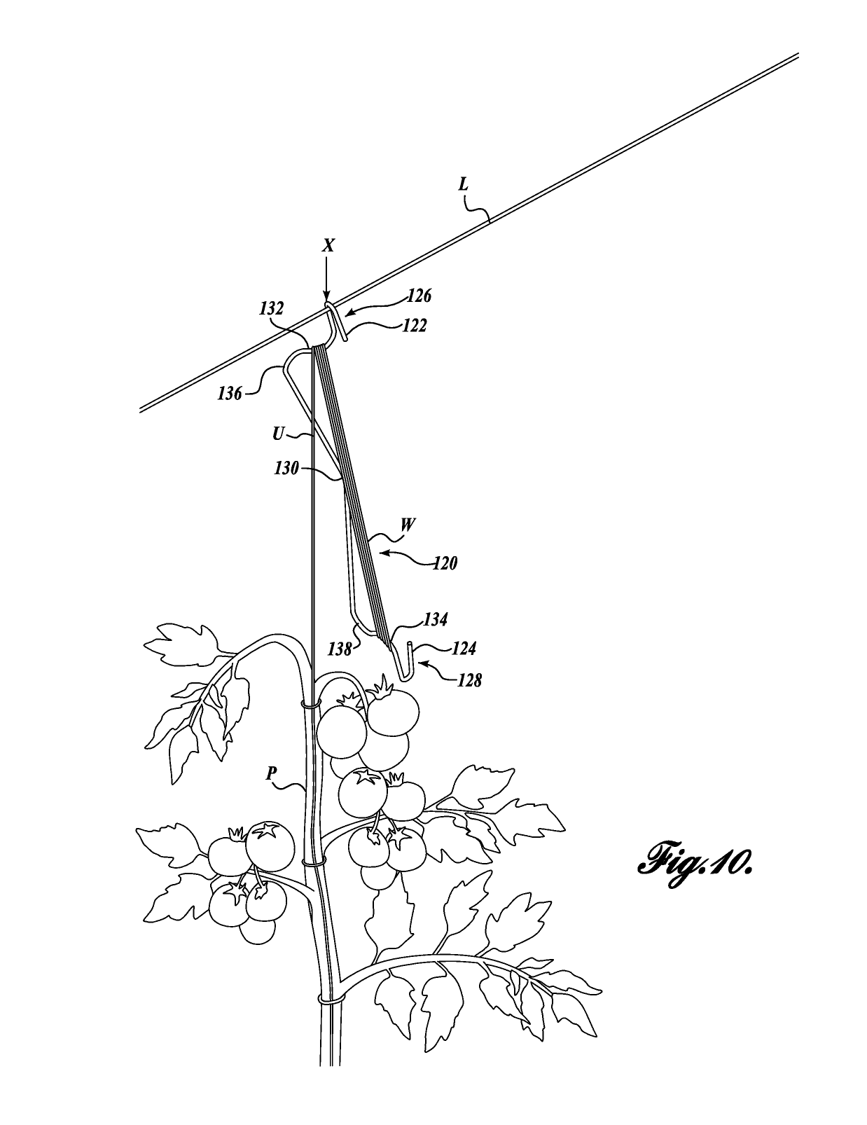

Referring to FIGS. 8 and 9, the crop hook 120 includes first and second hooks 122 and 124 positioned at respective first and second ends 126 and 128 of the crop hook 120, and a center body portion 130 for receiving and holding one or more windings of twine W (see FIGS. 9 and 10). Like the crop hook 20 of FIGS. 1-7, the body portion 130 has a serpentine configuration at the first and second ends 126 and 128 of the crop hook 30, defining first and second rounded twine collection portions 132 and 134 and first and second rounded twine holding portions 136 and 138.

Different from the crop hook 20 of FIGS. 1-7, the crop hook 120 of FIGS. 8-14 has a different configuration in the body portion 130 and a different angle between the first and second hooks 122 and 124. In that regard, at least one of the first and second hooks 122 and 124 is substantially non-planar with at least a portion of the body portion 130 of the crop hook 120. As can be seen FIG. 9, the body portion 130 of the illustrated embodiment is twisted, so as to extend in first and second planes. In that regard, the first and second rounded twine holding portions 136 and 138 are angled relative to each other, such that each extends in a plane that has about a 90 degree deviation from the other. In that regard, the first hook 122 extends in a direction relative to a longitudinal axis extending through the crop hook 20 and the second hook 124 extends in another direction. The body portion 130 may also extend in one or more other directions.

In addition to the angular deviation between the first and second rounded twine holding portions 136 and 138, like the first and second hooks 122 and 124, also have about a 90 degree deviation from each other (as opposed to being angled about 90 degrees relative to the body portion 30 and about 180 degrees relative to each other, as seen in the crop hook 20 of FIGS. 1 and 2). In that regard, the first hook 122 is rotated about 90 degrees from the first rounded twine holding portion 136, and the second hook 124 is also rotated about 90 degrees from the second rounded twine holding portion 138.

In the illustrated embodiment of FIG. 9, the first hook 122 protrudes outwardly from the paper toward the reader, the first rounded twine holding portion 136 extends about 90 degrees to the left side of the first hook 122. The second hook 124 extends about 90 degrees to the right side of the first hook 122, and the second rounded twine holding portion 136 extends about 90 degrees from the second hook 124, inwardly into the paper away from the reader.

Although in the illustrated embodiment, the first and second hooks 122 and 124 appear to be angled about 90 degrees relative to each other and their respective first and second rounded twine holding portions 136 and 138, it should be appreciated that non-square angles of the first and second hooks 122 and 124 relative to each other and the first and second rounded twine holding portions 136 and 138 may be advantageous. In that regard, the first and second hooks 120 and 124 may have a deviation angle in the range of about 70 to about 110 degrees, about 75 to about 105 degrees, about 80 to about 100 degrees, and about 85 to about 95 degrees relative to each other and/or the first and second rounded twine holding portions 136 and 138. Beyond the range of about 70 to about 110 degrees, it may be difficult to wind the hooks with twine on a machine.

The wound twine W may be wound in either the clockwise or counterclockwise direction around the body portion 130, depending on the preference of the user.

Referring to FIGS. 9-14, a method of using the crop hook 120 will now be described. Referring to FIGS. 9 and 10, the first hook 122 of the crop hook 120 hangs along the crop line L without user support at a first crop line position X, while the second hook 124 and the body portion 130 hang freely below the crop line L. Like the crop hook 20 of FIGS. 1-7, the crop hook 120 itself may not hang directly downward. Rather, it may hang at an angle (for example, in the range of about 10 to about 20 degrees from vertical) from the crop line L as a result of the weighting of the crop hook 120, the wound twine W, and the plant P attached to the unwound twine U.

Like the crop hook 20 of FIGS. 1-7, the illustrated embodiment of the crop hook 120 shown in FIGS. 8-14 is designed for movement by the user to the user's left along the crop line L. (Of note, the user is expected to be positioned behind the illustrated crop line L facing the crop line L in FIGS. 9-14; therefore, movement to the user's left is movement to the reader's right on the pages of FIGS. 9-14.) However, it should be appreciated that crop hooks 120 designed for movement to the user's right along the crop line L are also within the scope of the present disclosure. In that regard, the right-moving crop hook is substantially similar to the crop hook 120 of FIGS. 8-14, except that it is designed having the opposite configuration.

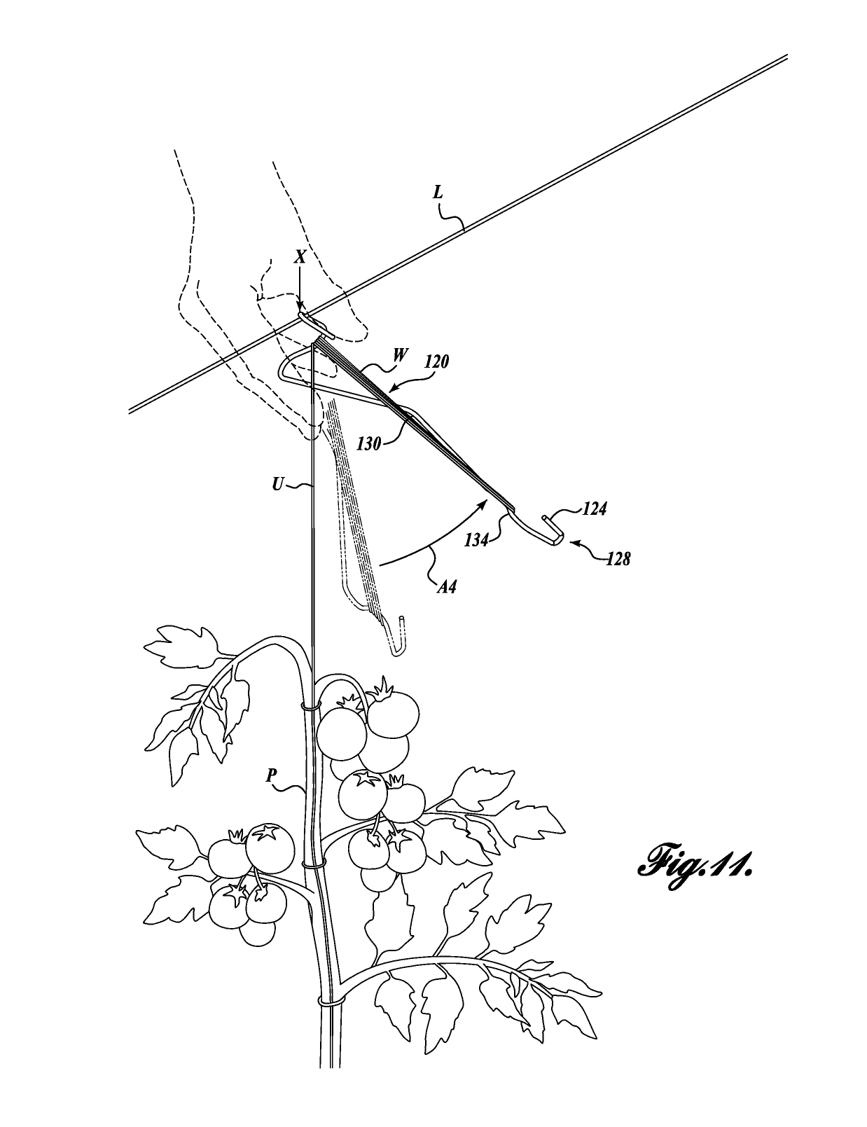

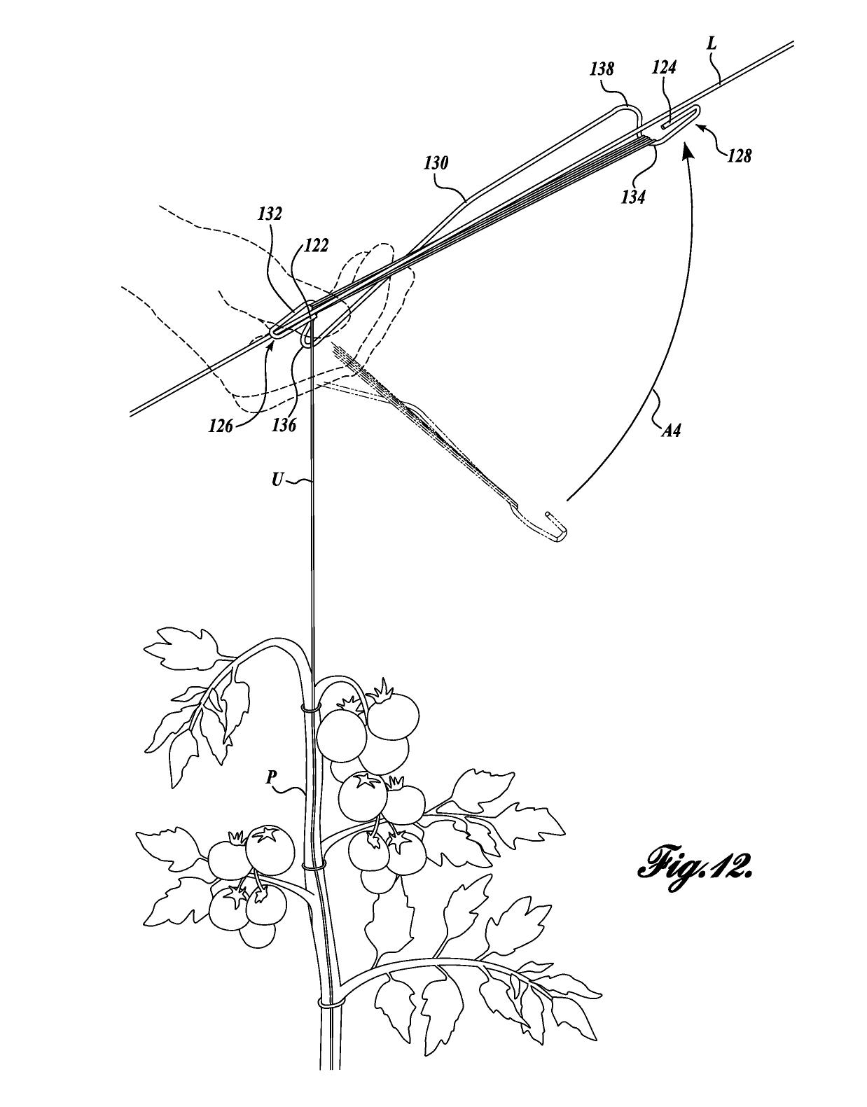

Referring now to FIGS. 11 and 12, the user uses his right hand to rotate the second end 128 of the crop hook 120 from its hanging position upward toward the crop line L to be parallel with the crop line L, as indicated by arrow A4, while maintaining the first hook 122 on or near the crop line L.

Referring to FIG. 12, as the user rotates the second end 128 toward the crop line L, the first end 126 of the crop hook 120 will slip off the crop line L. As the first end 126 of the crop hook 120 slips off the crop line L, the second end 128 also moves downwardly with gravity. The user can then use a swift movement of the fingers (e.g., not the whole hand) to rotate the crop hook 120 by about 90 degrees to rest the second end 128 of the crop hook 120 to the crop line L. Because of the angular orientation of the second end 128 of the crop hook 120 relative to the first end 126, the second end 128 is oriented to attach to the crop line L upon being rotated toward the crop line L without requiring significant rotation or manipulation of the crop hook 120 itself other than rotation along the path indicated by arrow A4.

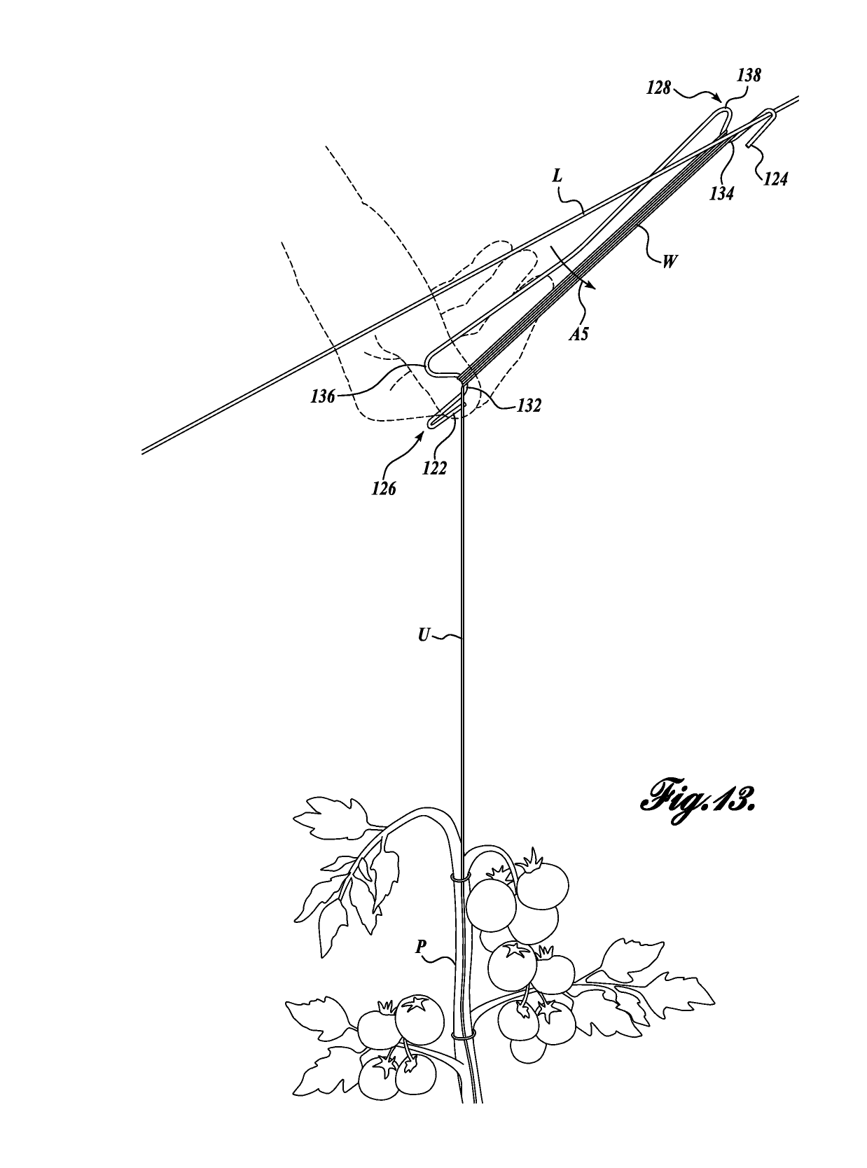

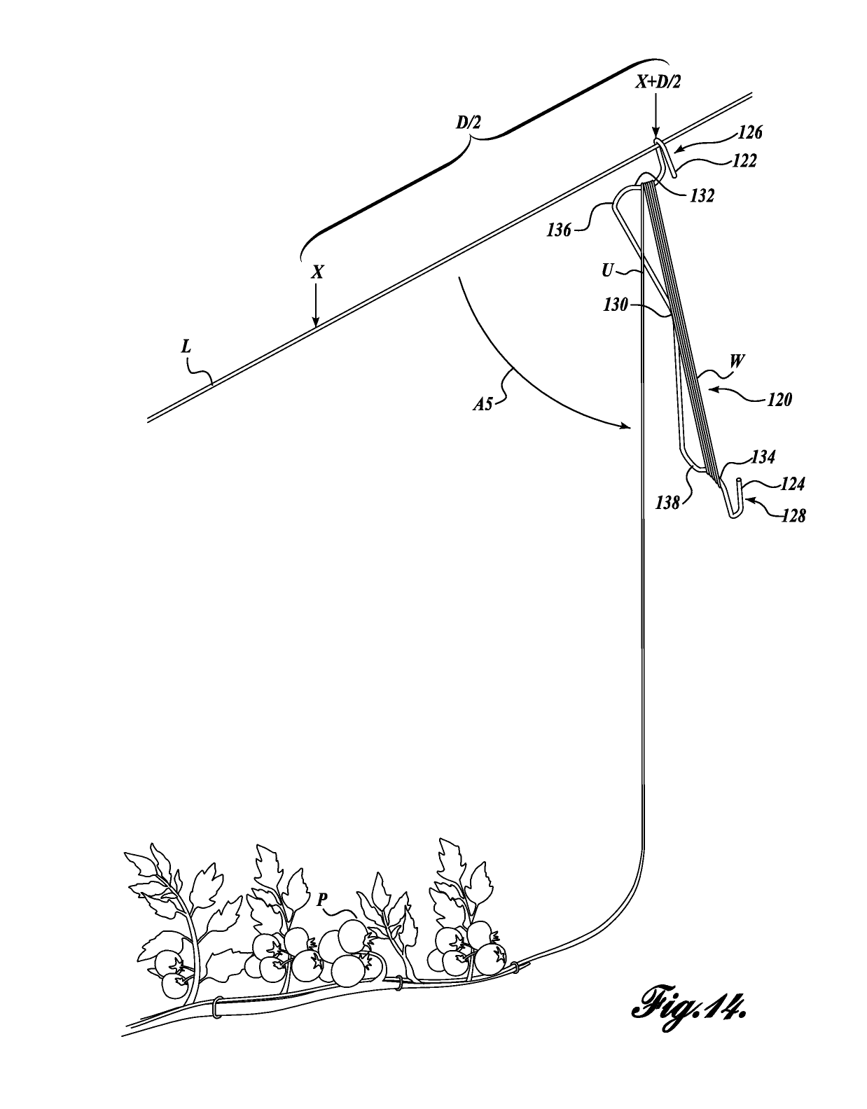

Referring to FIGS. 13 and 14, the crop hook 120 slips off the crop line L along the path indicated by arrow A5, and the second end 128 of the crop hook 120 attaches to the crop line L at a second crop line position of X+D/2. This operating movement allows the crop hook 120 to have an inverted orientation on the crop line L from its original orientation in FIG. 10. Such an inversion enables the release of a half winding length of wound twine W to the plant P. As the twine W unwinds from the crop hook 120, the user can guide the unwound twine U and the plant P into its new position with a portion of the vine of the plant P resting on the floor F of the environment (see, e.g., FIG. 9).

The advantage of the method of adjusting the plant P described herein is that the user is able to adjust the plant P by a half winding length of wound twine W (as opposed to a full winding length of wound twine W, as seen in FIGS. 3-7), while still minimizing the action of lifting the plant P. Minimizing lifting action provides great ease of use, as compared to use with the previously designed crop hook 220 (see FIG. 20).

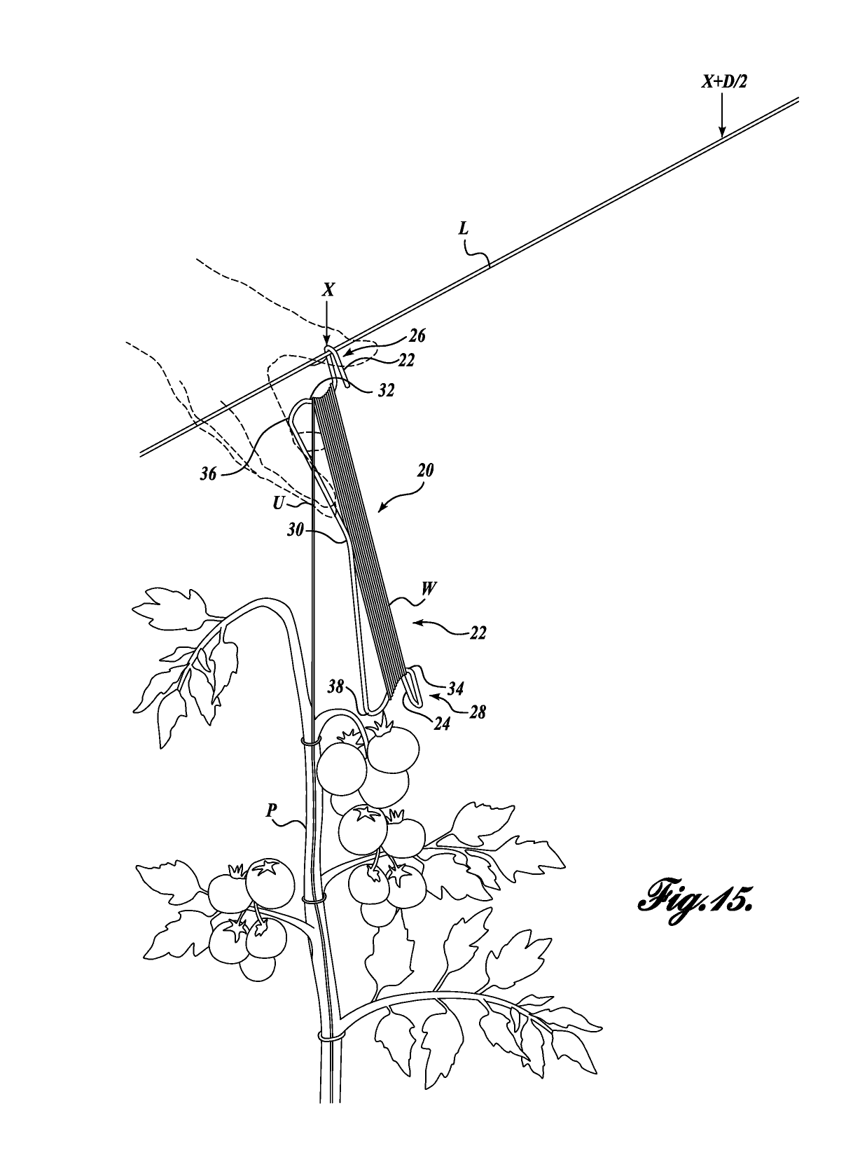

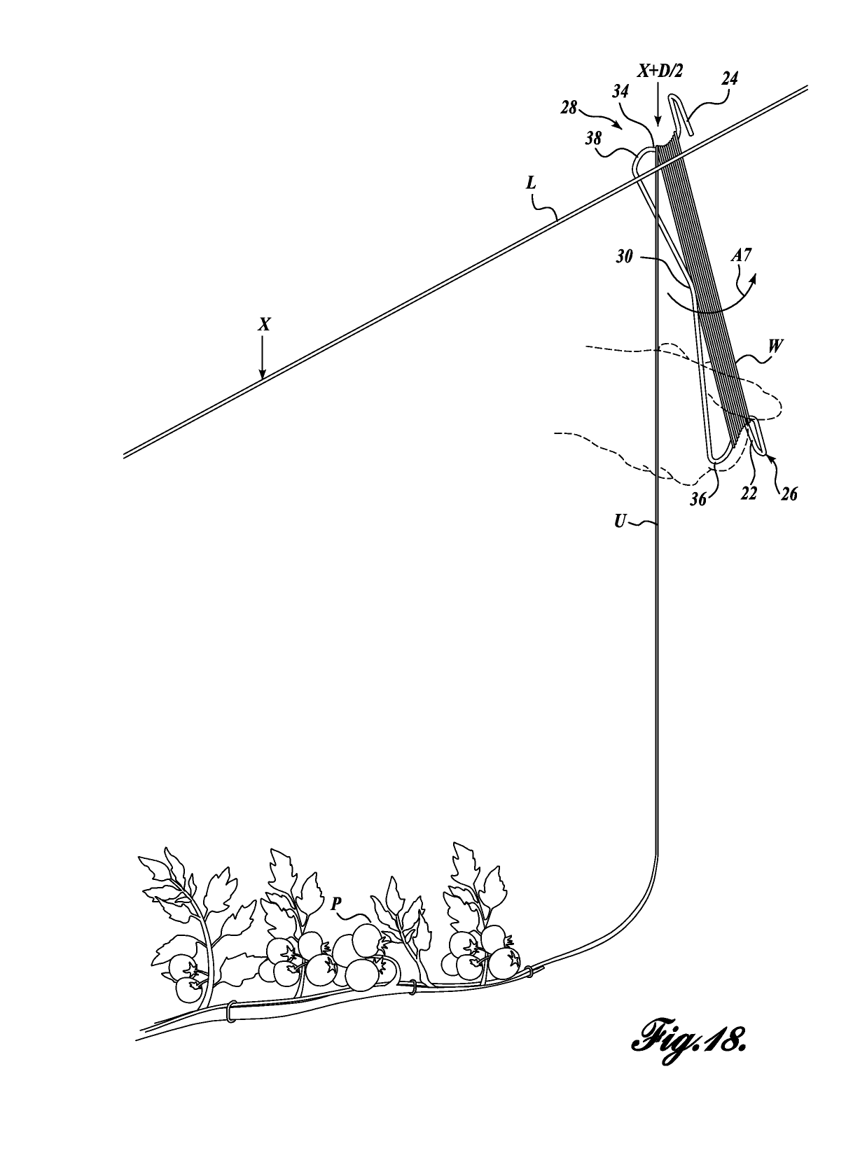

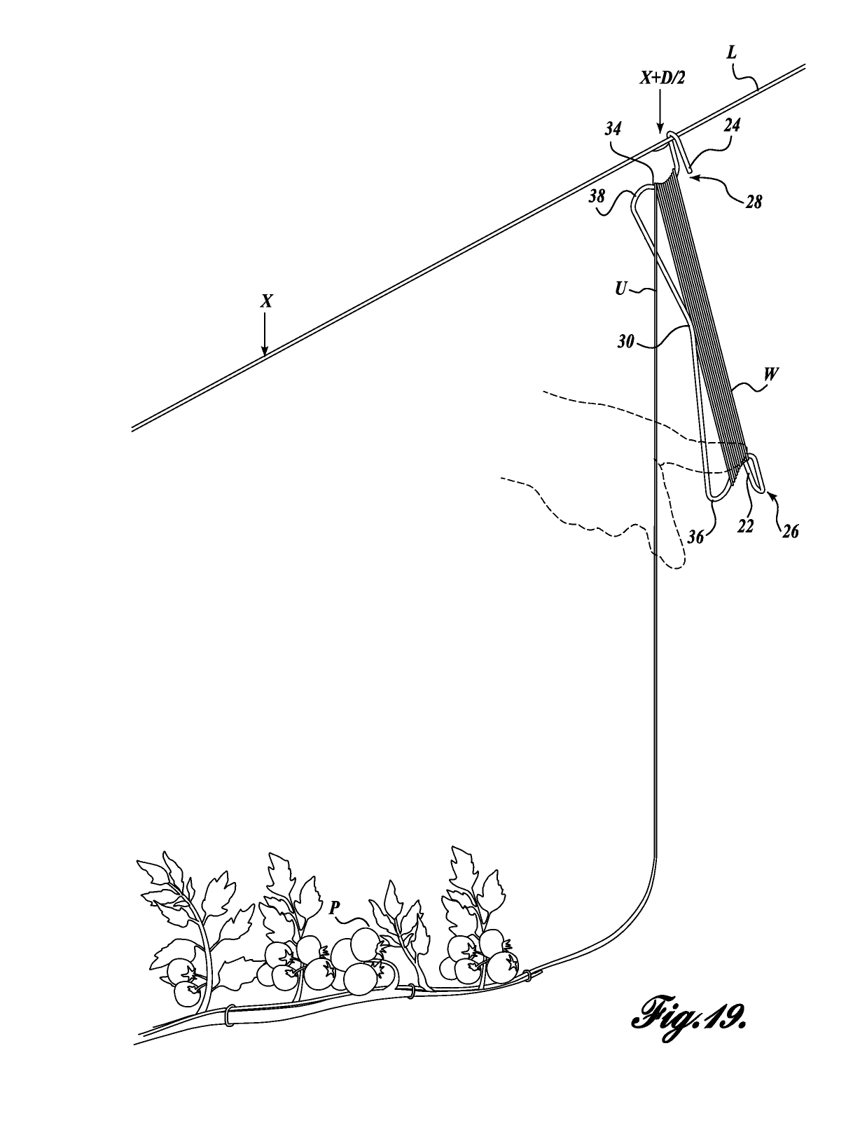

Referring now to FIGS. 15-19, it will be shown why a crop hook 20 according to the illustrated embodiment of FIGS. 1-7 is not optimized for releasing a half winding length of wound twine W in accordance with the method explained in FIGS. 10-14.

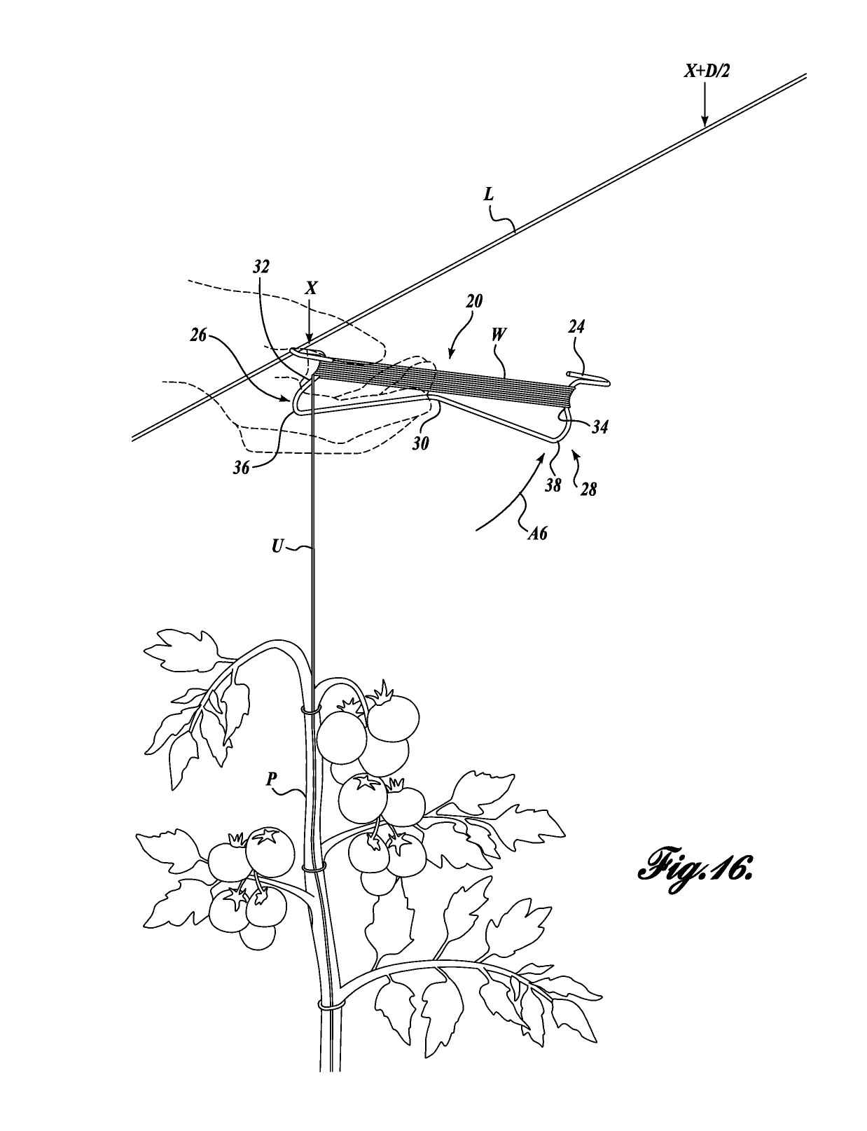

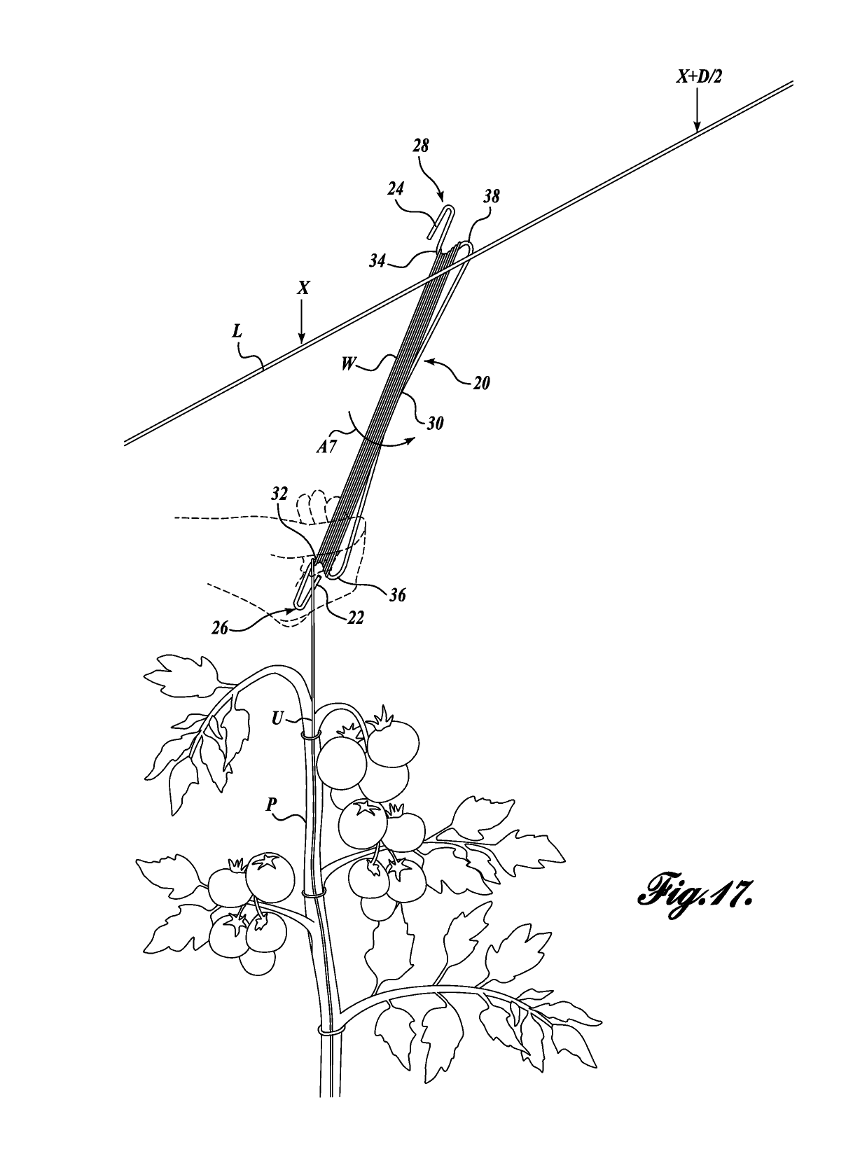

Referring to FIGS. 15 and 16, the user uses his right hand to rotate the second end 28 of the crop hook 20 from its hanging position upward toward the crop line L to be parallel with the crop line L, as indicated by arrow A6, while maintaining the first hook 22 on or near the crop line L. Referring to FIGS. 17-19, because of the angular orientation of the second end 28 of the crop hook 20 relative to the first end 26, the user must rotate the second end 28 of the crop hook 20 at least about 180 degrees, as indicated by arrow A7, to orient the second end 28 on the crop line L. This rotation of the hand with each crop hook 20 adjustment is awkward and uncomfortable for the user, particularly when performed in a repetitive series.

Referring now to FIG. 20, a previously designed crop hook 220 and a method of using the previously designed crop hook 220 will be described for comparison with the crop hook 20 and method of use for releasing a full winding length of wound twine W described with reference to FIGS. 1-7. As can be seen in FIG. 20, the previously designed crop hook 220 has a two-dimensional design. In that regard, the crop hook 220 includes first and second hooks 222 and 224 positioned at respective first and second longitudinal ends 226 and 228 of the crop hook 220, and a center body portion 230 for receiving and holding one or more windings of twine W. Both the first and second hooks 222 and 224 are substantially planar with the body portion 230 of the crop hook 220.

The body portion 230 has a serpentine configuration at the first and second ends 226 and 228 of the crop hook 230, defining first and second twine collection portions 232 and 234, and first and second twine holding portions 236 and 238. The twine holding portions 236 and 238 in the illustrated embodiment of the previously designed crop hook 220 are less rounded than the twine holding portions 36 and 38 in the embodiment shown in FIGS. 1-7.

In a resting position along a crop line L, the first hook 222 of the crop hook 220 will hang along the crop line L without user support at a first crop line position, while the second hook 224 and the body portion 230 will hang freely below the crop line L. The unwound twine U will hang in a substantially vertical orientation and travels from the crop line L to the floor or near the floor of the greenhouse (similar to the way in which the crop hook 20 hangs in FIG. 3). Several windings of wound twine W will be wound around the body portion 230 of the crop hook 220 and are available for unwinding.

Because of the design and configuration of the crop hook 220, when releasing a full winding length of unwound twine U to the plant P, the user will use his left hand to hold the crop hook 220, and his right hand to lift a winding of twine W off the twine holding portion 236 of the body portion 230. Then, the user will use his left hand to move the crop hook 220 to his left to the second position X+D along the crop line L. Therefore, the user must lift the weight of the plant being carried by the unwound twine U when releasing a full winding length of unwound twine U to the plant P and when adjusting the placement of the crop hook 220 on the crop line L. Over time, repetitive lifting can cause strain on the user's body that can lead to serious injury.

If the user were to use the previously designed crop hook 220 in the manner that the crop hook 20 of FIG. 1 is used, he would rotate the crop hook 220 away his body while it is attached to the crop line L to allow a full winding length of unwound twine U to be released from the twine holding portion 236 of the body portion 230. However, this method of rotation away from the user's body is as strenuous and awkward for the user as lifting the weight of the plant that is carried by the unwound twine U.

While illustrative embodiments have been illustrated and described, it will be appreciated that various changes can be made therein without departing from the spirit and scope of the invention.

The embodiments of the disclosure in which an exclusive property or privilege is claimed are defined as follows:

1. A crop hook, comprising:
(a) first and second ends, at least one of the first and second ends having a first hook; and
(b) a body portion between the first and second ends, wherein the first hook is substantially non-planar with at least a portion of the body portion.

2. The crop hook of claim 1, wherein the body portion includes first and second twine holding portions.

3. The crop hook of claim 2, wherein the first and second twine holding portions are angled relative to each other.

4. The crop hook of claim 2, wherein the first and second twine holding portions are substantially non-planar with each other.

5. The crop hook of claim 4, wherein the angle between the plane of the first twine holding portion and the plane of the second twine holding portion is selected from the group consisting of in the range of about 70 to about 110 degrees, in the range of about 75 to about 105 degrees, in the range of about 80 to about 100 degrees, and in the range of about 85 to about 95 degrees.

6. The crop hook of claim 2, wherein the first and second twine holding portions are substantially planar with each other.

7. The crop hook of claim 2, wherein the angle between the plane of the first hook and the plane of the first twine holding portion is selected from the group consisting of in the range of about 75 to about 105 degrees, in the range of about 80 to about 100 degrees, in the range of about 85 to about 95 degrees.

8. The crop hook of claim 1, wherein the other of the first and second ends has a second hook.

9. The crop hook of claim 8, wherein the second hook is substantially non-planar with at least a portion of the body portion.

10. The crop hook of claim 9, wherein the angle between the plane of the second hook and the plane of the second twine holding portion is selected from the group consisting of in the range of about 75 to about 105 degrees, in the range of about 80 to about 100 degrees, in the range of about 85 to about 95 degrees.

11. The crop hook of claim 8, wherein the second hook is substantially non-planar with the first hook.

12. The crop hook of claim 11, wherein the angle between the plane of the first hook and the plane of the second hook is selected from the group consisting of in the range of about 70 to about 110 degrees, in the range of about 75 to about 105 degrees, in the range of about 80 to about 100 degrees, and in the range of about 85 to about 95 degrees.

13. The crop hook of claim 1, wherein the body portion includes a twine collection portion.

14. The crop hook of claim 13, further comprising twine wound around the twine collection portion.

15. The crop hook of claim 14, wherein the twine is wound clockwise or counterclockwise.

16. A crop hook, comprising:
(a) first and second ends, at least one of the first and second ends having a first hook; and
(b) a body portion between the first and second ends, wherein the first hook is substantially non-planar with the body portion.

17. A crop hook, comprising:
(a) a first end having a first hook;
(b) a second end having a second hook; and
(c) a body portion between the first and second ends, wherein the body portion includes first and second twine holding portions, wherein each of the first and second hooks are substantially non-planar with at least a portion of the body portion.

18. The crop hook of claim 17, wherein the first and second twine holding portions are substantially non-planar with each other.

19. The crop hook of claim 18, wherein the angle between the plane of the first twine holding portion and the plane of the second twine holding portion is selected from the group consisting of in the range of about 70 to about 110 degrees, in the range of about 75 to about 105 degrees, in the range of about 80 to about 100 degrees, and in the range of about 85 to about 95 degrees.

20. A crop hook, comprising:
(a) first and second ends, the first end including a first hook and the second end including a second hook, wherein the first hook extends in a first direction relative to a longitudinal axis extending through the crop hook and wherein the second hook extends in a second direction relative to a longitudinal axis extending through the crop hook; and
(b) a body portion between the first and second ends.

21. The crop hook of claim 20, wherein the body portion extends in at least a third direction.

22. The crop hook of claim 20, wherein the body portion extends in at least a third direction and a fourth direction.

23. The crop hook of claim 20, wherein the body portion includes first and second twine holding portions.

24. The crop hook of claim 23, wherein the first and second twine holding portions extend in different directions relative to a longitudinal axis extending through the crop hook.

25. The crop hook of claim 24, wherein the angle between the direction of the first twine holding portion and the direction of the second twine holding portion is selected from the group consisting of in the range of about 70 to about 110 degrees, in the range of about 75 to about 105 degrees, in the range of about 80 to about 100 degrees, and in the range of about 85 to about 95 degrees.

26. The crop hook of claim 23, wherein the first and second twine holding portions extend in substantially the same direction.

27. The crop hook of claim 23, wherein the angle between the direction of the first hook and the direction of the first twine holding portion is selected from the group consisting of in the range of about 75 to about 105 degrees, in the range of about 80 to about 100 degrees, in the range of about 85 to about 95 degrees.

28. The crop hook of claim 23, wherein the angle between the direction of the second hook and the direction of the second twine holding portion is selected from the group consisting of in the range of about 75 to about 105 degrees, in the range of about 80 to about 100 degrees, in the range of about 85 to about 95 degrees.

29. The crop hook of claim 20, wherein the angle between the direction of the first hook and the direction of the second hook is selected from the group consisting of in the range of about 70 to about 110 degrees, in the range of about 75 to about 105 degrees, in the range of about 80 to about 100 degrees, and in the range of about 85 to about 95 degrees.

30. The crop hook of claim 20, wherein the body portion includes a twine collection portion.

31. The crop hook of claim 30, further comprising twine wound around the twine collection portion.

32. The crop hook of claim 31, wherein the twine is wound clockwise or counterclockwise.

33. A method of using a crop hook, the method comprising:
(a) supporting a crop twine on a crop hook, wherein the crop hook has a first end and a second end;
(b) hanging the crop hook on a crop line to hang the crop twine for supporting a plant having a plant weight;
(c) rotating the crop hook to release a length of twine from the crop hook without lifting the plant weight; and
(d) moving the crop hook a predetermined distance along the crop line without lifting the plant weight.

34. The method of claim 33, wherein rotating the crop hook includes rotating the second end of the crop hook in a plane up to 90 degrees from its original position relative to the first end.

35. The method of claim 34, wherein rotating the crop hook includes inverting the crop hook.
